(19) United States
(12) Patent Application Publication
(10) Pub. No.: US 2005/0197270 A1
(43) Pub. Date: Sep. 8, 2005

(54) Enzyme stabilization in liquid detergents

(75) Inventor: Svend Kaasgaard, Soborg (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 11/064,576

(22) Filed: Feb. 24, 2005

Related U.S. Application Data
(60) Provisional application No. 60/547,930, filed on Feb. 25, 2004.

(30) Foreign Application Priority Data
Feb. 24, 2004 (DK) 2004 00289

(51) Int. Cl. C11D 3/00

(52) U.S. Cl. 510/392

(57) ABSTRACT

The invention relates to the stabilization during storage of a enzymes comprised in liquid detergent compositions comprising less than 90% water by the addition of an antioxidant to the liquid detergent. Such antioxidant needs only be added in very small amounts. The antioxidant could be an oxidoreductase, such as e.g. a catalase.

### CROSS-REFERENCE TO RELATED APPLICATIONS

This application claims priority or the benefit under 35 U.S.C. 119 of Danish application no. PA 2004 00289 filed Feb. 24, 2004 and U.S. provisional application No. 60/547,930 filed Feb. 25, 2004, the contents of which are fully incorporated herein by reference.

### FIELD OF THE INVENTION

The present invention relates to a method for stabilizing an enzyme in a liquid detergent as well as to a stabilized liquid detergent free of bleaching agents.

### BACKGROUND OF THE INVENTION

Detergents for laundry and dish washing consist of complex mixtures of a wide variety of ingredients, which typically include a number of components selected from the following list: ionic and non-ionic surfactants, solvents, builders, perfumes, enzymes and bleaching components (the list is by no means exhaustive). In such complex mixtures storage stability problems are well known. The stability problems may be related to the physical stability of the detergent or to the functional stability of the individual ingredients in the detergent. Particularly maintaining the enzymatic activity in detergents during storage has been a challenge, especially if the detergent also includes bleaching components. Detergents comprising bleaching components such as peroxygen bleaches may result in a decreased stability of enzymes due to oxidation of the enzymes both in liquid and dry detergent formulations. Peroxides damage enzymes by means of oxidizing some of the amino acid residues in the protein. Especially methionine residues are prone to oxidation by peroxides. Especially when the methionine is present in or close to the active site, this may result in loss of activity but even oxidation of amino acid residues located far from the active site can affect the performance of the enzyme. In dry detergent formulations enzymes can be stabilized by e.g. encapsulation of the enzymes as described in WO 01/23513. Further stabilization can be achieved e.g. by adding catalase in small amounts as described in WO 02/38717 to the encapsulated enzymes.

Bleaching agents such as percarbonates and perborates are commonly used in powder detergents where they, together with bleach activators, such as tetra acetylethylenediamine (TAED) and nonanoyloxybenzenesulfonate (NOBS), act to generate peracids (e.g. peracetic acid), hydrogen peroxide or other related species upon addition of water during the wash cycle. The peracids or the other active oxygen species then act to bleach or lighten certain stains on the fabric or in the dish washing machine. However, the presence of bleaching agents in the detergent powder often has a strong negative effect on the stability of enzymes also present in the detergent. Consequently, great care is taken to separate the enzyme molecules and the bleaching agents in the detergent powder, e.g. by formulating both enzymes and the bleaching agents separately. The enzymes could be formulated in granulates prepared in such a way as to reduce the penetration of active oxygen species into enzyme containing granules. As a further means to protect the enzyme against oxidation in the granule, addition of an antioxidant such as thiosulphate, methionine or a catalase can help stabilizing the enzyme activity during storage of the dry detergent as described in WO 02/38717. In WO 02/38717 it is stressed that relatively small amounts of catalase, if compartmentalized and concentrated within a granule, as opposed to dispersed homogeneously throughout a detergent, together with an enzyme or other peroxide-sensitive active ingredients, sufficiently protected the enzyme or other active ingredients from the action of peracids or related species during storage. In the above described application it is important that the catalases, or other antioxidants, do not inactivate the bleaching agents neither during storage nor during the wash cycle in order not to destroy their stain removing effect.

Use of bleaching agents in liquid detergents is much less frequent, mainly due to a poor stability of the bleaching agent itself in liquid detergents containing significant amounts of water, i.e. >1% water. The presence of bleaching agents would also greatly affect the storage stability of oxidative sensitive enzymes and other oxidation sensitive compounds present in such detergents negatively. However, many liquid detergents still contain very low levels of peroxides for various reasons. Their function is not to act as bleaching agents during the wash cycle but they may be present as an impurity, e.g. if they have been used as bleaching agents in the production of some of the other ingredients present in a liquid detergent, e.g. in the production of surfactants. Also, we have discovered that in some cases peroxides may even be formed in the liquid detergent during storage. Despite that the level of peroxides in such liquid detergents are typically much lower than 1% by weight, they have a surprisingly significant negative effect on the stability of the enzymes also present in the detergent. In such liquid detergents a need therefore exists for providing increased stability of enzymes.

### SUMMARY OF THE INVENTION

It has now been found that even such small amounts of peroxides present or formed in liquid detergents will have a significant detrimental effect on enzyme stability during storage and that antioxidants, including some oxido-reductases, are able to perform their activity in concentrated liquid detergents comprising less than 90% water and by doing so are able to stabilize other enzymes and oxidation sensitive compounds present in the detergent.

In a first aspect the present invention therefore relates to a method of stabilizing a detersive enzyme in a liquid detergent composition comprising less than 90% water, said method comprising the addition of antioxidant to the liquid detergent.

In a second aspect the present invention relates to a liquid detergent composition comprising a detersive enzyme, less than 90 percent of water and an oxidoreductase.

In a third aspect the present invention relates to the use of an oxidoreductase for stabilizing an enzyme in a liquid detergent during storage.

### DETAILED DESCRIPTION OF THE INVENTION

The present invention relates to the stabilization of enzymes in liquid detergent compositions in which no bleaching agents have been added as such. The liquid detergent composition according to the invention comprises less than 1% peroxygen species. The content of peroxygen species can e.g. be measured as described by Binder and Menger, 2000 (Assay of peracid in the presence of excess hydrogen peroxide, Analytical Letters 33(3), 479-488)

“Bleaching agent” in the present context means agents of the chlorine/bromine-type such as lithium, sodium or calcium hypochlorite or hypobromite as well as chlorinated trisodium phosphate, N-chloro-isocyanurates or the oxygen-type such as perborate or percarbonate, which may be combined with a peracid-forming bleach activator such as a TAED or NOBS, hydrogen peroxid or other hydroperoxides e.g. of unsaturated fatty acids.

In the present invention enzymes in liquid detergents, particularly proteolytic enzymes have been found to be unstable. Since no bleaching agents were added, enzyme stability was not expected to be affected by the presence of peroxides in very low amounts. However, in the present invention it has now been found that addition of antioxidants, including methionine or thiosulphate or oxidoreductases, e.g. peroxidases or catalases, will result in stabilization of enzymes in liquid detergents.

According to Enzyme Nomenclature (published by Nomenclature Committee of the International Union of Biochemistry and Molecular Biology, Academic Press (1992)) oxidoreductases are a common term for e.g. hydrogenases, oxidases and peroxidases. Catalases (EC 1.11.1.6) belong to a specific subgroup of peroxidases where hydrogen peroxide acts both as hydrogen donor and hydrogen acceptor. Other peroxidases have hydrogen peroxide as electron acceptor while the electron donor can be various organic or inorganic compounds such as glutathione, chloride, bromide, NADH, Mn(II) or fatty acids.

Stabilization of an enzyme in the context of the present invention means that the presence of an antioxidant, especially an oxidoreductase, e.g. a peroxidase, particularly a catalase, will prevent or reduce the oxidation of e.g. methionine residues in the detersive enzyme resulting in a higher proportion of active enzyme being maintained in the liquid detergent during storage. Alternatively, the prevention of oxidation can lead to stabilization of the active enzyme by preventing structural changes in the active enzyme, which could otherwise render the enzyme more vulnerable towards proteolytic attack from proteases.

Within the group of oxido-reductases, peroxidases and especially catalases are particularly suited as antioxidants according to this invention as they or their reaction products do not affect the odour of the detergent. Other antioxidants may also be useful but care should be taken not to select antioxidants, which will provide a mal-odour to the detergent. Especially many antioxidants containing sulfur such as mercaptoethanol, dithiotreitol, methionine or thiosulphate can also be used, but some of these have a characteristic off-odour, which in some cases can be undesirable. The perception of mal-odour will depend on the concentration of the antioxidant used and of other ingredients in the detergent such as perfumes.

The oxidizing compounds may be peracids, hydrogen peroxide, other peroxo compounds or other active oxygen species (such as perborates or percarbonates). Their presence may be caused by other components of the detergent. They may have been added deliberately or they may be formed via a peroxide generating system during storage of the complete detergent. The formation of peroxides during storage of the surfactant Tween 20 and Triton X-100 has thus been described by J. Jaeger, K. Sorensen and S. P. Wolff in J. Biochem. Biophys. Methods 29 (1994) 77-81.

Enzymes

The enzymes that can be stabilized according to the invention are in the context of the present invention referred to as “detersive enzymes”, which as used herein means any enzyme which exerts their effects during the wash cycle, e.g. having a cleaning, fabric care, anti-redeposition and stain removing effect in a wash application and which enzymes are added for such a purpose. Suitable enzymes include lyases or hydrolases (EC 3.-.-.-), particularly proteases, amylases, lipases, pectate lyases, carbohydrases and/or cellulases as elaborated below.

Preferred hydrolases in the context of the invention are: Carboxylic ester hydrolases (EC 3.1.1.-) such as lipases (EC 3.1.1.3); phytases (EC 3.1.3.-), e.g. 3-phytases (EC 3.1.3.8) and 6-phytases (EC 3.1.3.26); glycosidases (EC 3.2.-.-, which fall within a group denoted herein as “carbohydrases”) such as α-amylases (EC 3.2.1.1); peptidases (EC 3.4.-.-, also known as proteases); and other carbonyl hydrolases.

In the present context, the term “carbohydrase” is used to denote not only enzymes capable of breaking down carbohydrate chains (e.g. starches or cellulose) of especially five- and six-membered ring structures (i.e. glycosidases, EC 3.2.-.-, but also enzymes capable of isomerizing carbohydrates, e.g. six-membered ring structures such as D-glucose to five-membered ring structures such as D-fructose.

Carbohydrases of relevance include the following (EC numbers in parentheses): α-amylases (EC 3.2.1.1), β-amylases (EC 3.2.1.2), glucan 1,4-α-glucosidases (EC 3.2.1.3), endo-1,4-beta-glucanase (cellulases, EC 3.2.1.4), endo-1,3(4)-β-glucanases (EC 3.2.1.6), endo-1,4-β-xylanases (EC 3.2.1.8), dextranases (EC 3.2.1.11), chitinases (EC 3.2.1.14), polygalacturonases (EC 3.2.1.15), lysozymes (EC 3.2.1.17), β-glucosidases (EC 3.2.1.21), α-galactosidases (EC 3.2.1.22), β-galactosidases (EC 3.2.1.23), amylo-1,6-glucosidases (EC 3.2.1.33), xylan 1,4-β-xylosidases (EC 3.2.1.37), glucan endo-1,3-β-D-glucosidases (EC 3.2.1.39), α-dextrin endo-1,6-α-glucosidases (EC3.2.1.41), sucrose α-glucosidases (EC 3.2.1.48), glucan endo-1,3-α-glucosidases (EC 3.2.1.59), glucan 1,4-β-glucosidases (EC 3.2.1.74), glucan endo-1,6-β-glucosidases (EC 3.2.1.75), arabinan endo-1,5-α-L-arabinosidases (EC 3.2.1.99), lactases (EC 3.2.1.108), chitosanases (EC 3.2.1.132) and xylose isomerases (EC 5.3.1.5), endo-mannanase (EC 3.2.1.78).

Examples of commercially available proteases (peptidases) include Kannase™, Everlase™, Esperase™, Alcalase™, Neutrase™, Durazym™, Savinase™, Pyrase™, Pancreatic Trypsin NOVO (PTN), Bio-Feed™ Pro and Clear-Lens™ Pro (all available from Novozymes A/S, Bagsvaerd, Denmark).

Other commercially available proteases include Maxatase™, Maxacal™, Maxapem™, Opticlean™ and Purafect™ (available from Genencor International Inc.)

Examples of commercially available lipases include Lipex™, Lipoprime™ Lipolase™, Lipolase™ Ultra, Lipozyme™, Palatase™, Novozym™ 435 and Lecitase™ (all available from Novozymes A/S).

Other commercially available lipases include Lumafast™ (Pseudomonas mendocina lipase from Genencor International Inc.); Lipomax™ (Ps. pseudoalcaligenes lipase from Genencor Int. Inc); and Bacillus sp. lipase from Genencor International Inc. Further lipases are available from other suppliers.

Examples of commercially available carbohydrases include Alpha-Gal™, Bio-Feed™ Alpha, Bio-Feed™ Beta, Bio-Feed™ Plus, Bio-Feed™ Plus, Novozyme™ 188, Celluclast™, Cellusoft™, Ceremyl™, Citrozym™, Denimax™, Dezyme™, Dextrozyme™, Finizym™, Fungamyl™, Gamanase™, Glucanex™, Lactozym™, Maltogenase™, Pentopan™, Pectinex™, Promozyme™, Pulpzyme™, Novamyl™, Termamyl™ , AMG™ (Amyloglucosidase Novozymes A/S), Maltogenase™, Sweetzyme™, Mannaway™ and Aquazym™ (all available from Novozymes A/S). Further carbohydrases are available from other suppliers.

Such enzymes, herein described as detersive enzymes, are normally incorporated into detergent compositions at levels sufficient to provide an in-wash effect, which will be known to the skilled person in the art. Normally this would be in the range from 0.001% (w/w) to 5% (w/w). Typical amounts are in the range from 0.01% to 1% by weight of the liquid detergent composition.

Antioxidants

In the present invention, the term antioxidant covers antioxidant compounds active against hydrogen peroxide and/or other peroxygen species. They include antioxidants such as mercaptoethanol, Butylated hydroxytoluene (BHT), Butylated hydroxyanisol (BHA), ascorbate, methionine or thiosulphate and enzymes, which have hydrogen peroxide as a substrate, i.e. enzymes having oxido-reductase activity. An essential element according to the invention is the addition of an antioxidant to the detergent composition. The antioxidants according to the invention comprise antioxidants which exerts their antioxidant effect in the concentrated liquid detergent composition of the invention. Antioxidants include H₂O₂ scavenging material, which is selected from compounds which react with H₂O₂ via a decomposition, neutralization or adsorption process or any combination thereof. Suitable compounds, which react with H₂O₂ via a decomposition process, are selected from methionine, thiosulphate, ascorbate, oxidoreductases, e.g. peroxidases or catalases. We have found that the antioxidants ascorbate, methionine and catalase have proven particularly useful as antioxidants. In a particular embodiment of the present invention the antioxidants are selected from the group consisting of ascorbate, methionine and catalase.

In a particular embodiment the antioxidant is an oxidoreductase (EC 1.-.-.-) more particularly a peroxidase (EC 1.11.1.-) even more particularly a catalase (EC 1.11.1.6).

In a further embodiment according to the invention the antioxidant is present in the detergent composition before adding the detersive enzyme.

Addition of the antioxidant will in a particular embodiment serve to stabilize the detersive enzyme during storage of the detergent composition. The stabilizing effect can be achieved by the addition of low levels of the antioxidant. In the case when the antioxidant is itself an enzyme, e.g. in the form of an oxidoreductase (EC 1.-.-.-), the level of enzyme needed in order to obtain the stabilizing effect is much lower than the level of detersive enzyme applied to the detergent composition. The amount of antioxidant in the form of an oxidoreductase such as e.g. catalase should in a particular embodiment be added in amounts relative to the detergent of less than 50 μg/g detergent, particularly less than 20 pg/g detergent, more particularly less than 1 μg/g detergent, even more particularly less than 0.5 μg/g detergent on protein basis.

In a particular embodiment of the present invention the amount of methionine and/or ascorbate should be added in amounts relative to the detergent of more than 0.1 mg/g detergent on protein basis, such as more than 0.5 mg/g detergent, even more than 1 mg/g detergent. In a particular embodiment of the present invention the amount should not exceed 10 mg/g detergent.

As stated above the detersive enzyme is typically present in amounts corresponding to 0.01 to 10 mg/g detergent, and thus in one embodiment of the invention the molecular ratio of antioxidant to detersive enzyme is from 1:10000 to 1:5, particularly 1:5000 to 1:10, more particularly from 1:3000 to 1:100.

Catalases according to the invention can in a particular embodiment be obtained from a bacteria or a fungus, particularly a filamentous fungus. In a more particular embodiment the catalase is obtainable from the group consisting of Aspergillus niger, Aspergillus oryzae, Scytalidium thermophilum, Micrococcus luteus, Streptomyces coelicolor, Thermomyces lanuginosus, and Bacillus subtilis.

Particularly the catalase is from A. oryzae or S. thermophilum. Examples of commercially available catalases are Terminox™ and Terminox Ultra™ (Novozymes A/S, Bagsvaerd, Denmark) and Catalase T100™ (Genencor International Inc.)

Liquid Compositions

The liquid detergent composition of the invention is in one embodiment substantially non-aqueous (or anhydrous) in character. The term “substantially non-aqueous” as used in this context means that while very small amounts of water may be incorporated into such preferred compositions as an impurity in the essential or optional components, the amount of water in non-aqueous liquid detergent compositions of the invention should in no event exceed about 30% by weight of the composition. More preferably, water content of the non-aqueous detergent composition will comprise less than about 10% by weight.

The liquid detergent composition according to the invention is in another embodiment a concentrated liquid detergent composition comprising more than 30% water but less than 90%. The amount of water comprised in the liquid detergent composition is particularly less than 85%, more particularly less than 75%, such as less than 60% by weight of the liquid detergent. The detergent will, however, contain water as described above, and this amount of water should at least be 1%, more particularly at least 5%, more particularly 20%, even more particularly at least 30%. The liquid detergent composition comprise in a particular embodiment between 30% to 70% of water by weight of the liquid detergent. In a more particular embodiment the liquid detergent comprise between 40% to 60% of water by weight of liquid detergent. In a most particular embodiment the liquid detergent comprise between 80% to 90% of water by weight of liquid detergent.

In a further embodiment the invention relates to a liquid detergent composition comprising a detersive enzyme, less than 90% of water (w/w) and an oxidoreductase.

Liquid detergent compositions according to the invention are conventional compositions normally used in laundry or dishwashing applications.

Surfactant

The detergent composition of the invention comprises one or more surfactants, which may be non-ionic including semi-polar and/or anionic and/or cationic and/or zwitterionic. The amount of the surfactant mixture component of the detergent compositions herein can vary depending upon the nature and amount of other composition components and depending upon the desired rheological properties of the ultimately formed composition. Generally, this surfactant mixture will be used in an amount comprising from about 0.1% to 90% by weight of the composition. More preferably, the surfactant mixture will comprise from about 10% to 60% by weight of the composition.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap. Highly preferred anionic surfactants are the linear alkyl benzene sulfonate (LAS) materials. Such surfactants and their preparation are described for example in U.S. Pat. Nos. 2,220,099 and 2,477,383, incorporated herein by reference. Especially preferred are the sodium and potassium linear straight chain alkylbenzene sulfonates, in which the average number of carbon atoms in the alkyl group is from about 11 to 14. Sodium C₁₁-C₁₄, e.g., C₁₂ LAS is especially preferred. Other useful anionic surfactants are described in WO 99/0478, pages 11 through 13, incorporated herein by reference.

When included therein the detergent will usually contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”). Such useful non-ionic surfactants are further described in WO 99/0478, pages 13 through 14, incorporated herein by reference.

The detergent may also contain ampholytic and/or zwitterionic surfactants. A typical listing of anionic, non-ionic, ampholytic and zwitterionic surfactants is given in U.S. Pat. No. 3,664,961 issued to Norris on May 23, 1972.

Non-Aqueous Liquid Diluent

To form the liquid phase of the detergent compositions, the hereinbefore described surfactant (mixture) may be combined with a non-aqueous liquid diluent such as a liquid alcohol alkoxylate material or a non-aqueous, low-polarity organic solvent such as described in WO 99/0478 (pages 14 through 17). A non-aqueous, low-polarity organic solvent(s) employed should, of course, be compatible and non-reactive with other composition components, e.g. enzymes and/or bleach and/or activators used in the liquid detergent compositions herein. Such a solvent component will generally be utilized in an amount of from about 1% to 60% by weight of the composition. More preferably, the non-aqueous, low-polarity organic solvent will comprise from about 5% to 40% by weight of the composition, most preferably from about 10% to 25% by weight of the composition.

EDDS

The compositions of the invention may contain from about 0.01% to about 10%, preferably from about 0.05% to about 2%, of ethylenediamine-N,N′-disuccinic acid (EDDS) or the alkali metal, alkaline earth metal, ammonium, or substituted ammonium salts thereof, or mixtures thereof. Preferred EDDS compounds for liquid detergent compositions are the free acid form and sodium or potassium salts thereof. EDDS are described in U.S. Pat. No. 4,704,233.

EDDS improves the efficiency of enzymes, especially amylases, in liquid non-aqueous detergent compositions upon dilution in the wash liquor.

Chelating Agents

The liquid detergent compositions according to the present invention may also contain 0-65% w/w other chelating agents. Such chelating agents can be selected from the group consisting of amino carboxylates, amino phosphonates, polyfunctionally-substituted aromatic chelating agents, diphosphate, triphosphate, carbonate, citrate, nitrilotriacetic acid, ethylenediaminetetraacetic acid, diethylenetriaminepentaacetic acid, alkyl- or alkenylsuccinic acid, soluble silicates or layered silicates (e.g. SKS-6 from Hoechst) and mixtures thereof. Further chelating agents are described in WO 99/00478.

Enzyme Stabilizers

The enzyme(s) in the liquid detergent may also be stabilized conventionally using stabilizing agents in the liquid phase, e.g. a polyol such as propylene glycol or glycerol, a sugar or sugar alcohol, lactic acid, short chained carboxylic acids such as formate or acetate, boric acid, or a boric acid derivative, e.g. an aromatic borate ester, or a phenyl boronic acid derivative such as 4-formylphenyl boronic acid, and the composition may be formulated as described in e.g. WO 92/19709 and WO 92/19708.

The enzyme of the invention may additionally be incorporated into the detergent formulations disclosed in WO 97/07202.

Particulate Material Other Than Enzyme Particles

The liquid detergent compositions of the invention may further comprise a solid phase of particulate material, which is dispersed and suspended within the liquid phase. Generally, such particulate material will range in size from about 0.1 to 1500 μm. More preferably such material will range in size from about 5 to 500 μm.

The particulate material utilized herein can comprise one or more types of detergent composition components, which in particulate form are substantially insoluble in the liquid phase of the composition. The types of particulate materials, which can be utilized, may be selected from the following non-limiting list of useful components

Particulate surfactants, which can be suspended in e.g. the non-aqueous liquid detergent compositions herein includes ancillary anionic surfactants, which are fully or partially insoluble in the non-aqueous liquid phase. The most common type of anionic surfactant with such solubility properties comprises primary or secondary alkyl sulphate anionic surfactants. Such surfactants are those produced by the sulphate ion of higher C₈-C₂₀ fatty alcohols. Further examples of such useful surfactants are described in WO 99/00478 (pages 21-22). If utilized as all or part of the requisite particulate material, ancillary anionic surfactants such as alkyl sulphates will generally comprise from about 1% to 10% by weight of the composition, more preferably from about 1% to 5% by weight of the composition. Alkyl sulphate used as all or part of the particulate material is prepared and added to the compositions herein separately from the non-alkoxylated alkyl sulphate material which may form part of the alkyl ether sulphate surfactant component essentially utilized as part of the liquid phase herein.

Solid organic builder material. Such compounds serve to counteract the effects of calcium, or other ions, water hardness encountered during laundering and/or bleaching use of the compositions herein. Examples of such materials include the alkali metal, citrates, succinates, malonates, fatty acids, carboxymethyl succinates, carboxylates, polycarboxylates and polyacetyl carboxylates. Specific examples include sodium, potassium and lithium salts of oxydisuccinic acid, mellitic acid, benzene polycarboxylic acids and citric acid. Other examples are organic phosphonate type sequestering agents such as those which have been sold by Monsanto under the Dequest tradename and alkanehydroxy phosphonates. Citrate salts are highly preferred. Other suitable organic builders include the higher molecular weight polymers and copolymers known to have builder properties. For example, such materials include appropriate polyacrylic acid, polymaleic acid, and polyacrylic/polymaleic acid copolymers and their salts, such as those sold by BASF under the Sokalan trademark. Another suitable type of organic builder comprises the water-soluble salts of higher fatty acids, i.e., “soaps”. These include alkali metal soaps such as the sodium, potassium, ammonium, and alkylammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. If utilized as all or part of the requisite particulate material, insoluble organic detergent builders can generally comprise from about 1% to 20% by weight of the compositions herein. More preferably, such builder material can comprise from about 4% to 10% by weight of the composition.

Solid inorganic alkalinity source compounds may also be incorporated in the detergent composition of the invention. Such compounds can comprise a material, which serves to render aqueous washing solutions formed from compositions of the invention generally alkaline in nature. Such materials may or may not also act as detergent builders, i.e. as materials which counteract the adverse effect of water hardness on detergency performance. Examples of suitable alkalinity sources include water-soluble alkali metal carbonates, bicarbonates, borates, silicates and metasilicates. Although not preferred for ecological reasons, water-soluble phosphate salts may also be utilized as alkalinity source. These include alkali metal pyrophosphates, orthophosphates, polyphosphates and phosphonates. Of all of these alkalinity sources, alkali metal carbonates such as sodium carbonate are the most preferred. The alkalinity source, if in the form of a hydratable salt, may also serve as a desiccant in a non-aqueous liquid detergent composition. The presence of an alkalinity source, which is also a desiccant may provide benefits in terms of chemically stabilizing those composition components such as the peroxygen bleaching agent which may be susceptible to deactivation by water. If utilized as all or part of the particulate material component, the alkalinity source compounds will generally comprise from about 1% to 15% by weight of the compositions herein. More preferably, the alkalinity source can comprise from about 2% to 10% by weight of the composition. Such materials, while water-soluble, will generally be insoluble in a non-aqueous detergent composition and such materials will generally be dispersed in a non-aqueous liquid phase in the form of discrete particles.

Optional Detergent Ingredients

The detergent may also contain other optional detergent ingredients. The optional components may either dissolve in the liquid phase or may be dispersed within the liquid phase in the form of fine particles or droplets. The types of materials, which can be utilized, may be selected from the following non-limiting list of useful components:
Inorganic Detergent Builders. The detergent composition of the invention may also optionally contain one or more types of inorganic detergent builders beyond those listed hereinbefore that also function as alkalinity sources or chelating agents. Such optional inorganic builders can include, for example, aluminosilicates such as zeolites. Aluminosilicate zeolites and their use as detergent builders are more fully discussed in Corkill et al., U.S. Pat. No. 4,605,509; issued Aug. 12, 1986. Also crystalline layered silicates, such as those discussed in this '509 U.S. patent, are also suitable for use in the detergent compositions herein. If utilized, optional inorganic detergent builders can comprise from about 2% to 15% by weight of the compositions herein.
Thickening, Viscosity Control and/or Dispersing Agents. The detergent composition of the invention may also optionally contain a polymeric material which serves to enhance the ability of the composition to maintain its solid particulate components in suspension. Such materials may thus act as thickeners, viscosity control agents and/or dispersing agents. Such materials are frequently polymeric polycarboxylates but can include other polymeric materials such as polyvinylpyrrolidone (PVP), carboxymethylcellulose, poly (ethylene glycol), poly(vinyl alcohol), poly(vinylpyridine-N-oxide), poly(vinyl-imidazole) and polymeric amine derivatives such as quaternized, ethoxylated hexamethylene diamines. Polymeric polycarboxylate materials can be prepared by polymerising or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid, methylenemalonic acid and lauryl methacrylic acid. The presence in the polymeric polycarboxylates herein of monomeric segments, containing no carboxylate radicals such as vinylmethyl ether, styrene, ethylene, etc. is suitable provided that such segments do not constitute more than about 40% by weight of the polymer. Particularly suitable polymeric polycarboxylates can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000, and most preferably from about 4,000 to 5,000. Water-soluble salts of such acrylic acid polymers can include, for example, the alkali metal salts. Soluble polymers of this type are known materials. Use of polyacrylates of this type in detergent compositions has been disclosed, for example, Francis L. Diehl, U.S. Pat. No. 3,308,067, issued Mar. 7, 1967. Such materials may also perform a builder function. If utilized, the optional thickening, viscosity control and/or dispersing agents should be present in the compositions herein to the extent of from about 0.1% to 4% by weight. More preferably, such materials can comprise from about 0.5% to 2% by weight of the detergents compositions herein.
Optional Brighteners, Suds Suppressers and/or Perfumes. The detergent composition of the invention herein may also optionally contain conventional brighteners, suds suppressers, silicone oils, bleach catalysts, and/or perfume materials. Such brighteners, suds suppressers, silicone oils, bleach catalysts, and perfumes must, of course, be compatible and non-reactive with the other composition components in the environment of the liquid detergent composition. If present, brighteners, suds suppressers and/or perfumes will typically comprise from about 0.01% to 5% by weight of the compositions herein. Suitable bleach catalysts include the manganese based complexes disclosed in U.S. Pat. No. 5,246,621, U.S. Pat. No. 5,244,594, U.S. Pat. No. 5,114,606 and U.S. Pat. No. 5,114,611.
Optional Organic Additives. The detergent composition of the invention may contain an organic additive. A preferred organic additive is hydrogenated castor oil and its derivatives. Hydrogenated castor oil is a commercially available commodity being sold, for example, in various grades under the trademark CASTORWAX.RTM. by NL Industries, Inc., Highstown, N.J. Other suitable hydrogenated castor oil derivatives are Thixcin R, Thixcin E, Thixatrol S T, Perchem R and Perchem S T. Especially preferred hydrogenated castor oil is Thixatrol S T. The castor oil can be added as a mixture with for example stereamide. The organic additive will be partially dissolved in a non-aqueous liquid diluent. To form the structured liquid phase required for suitable phase stability and acceptable rheology, the organic additive is generally present to the extent of from about 0.05% to 20% by weight of the liquid phase. More preferably, the organic additive will comprise from about 0.1% to 10% by weight of the liquid phase of the detergent compositions of the invention.
Other optional detergent ingredients such as fabric conditioners including clays, foam boosters, anti-corrosion agents, soil-suspending agents, anti-soil redeposition agents, dyes, bacteriocides, hydrotropes and tarnish inhibitors.
   pH

The alkalinity of a concentrated liquid detergent is difficult to measure, and when comparing different detergents with respect to pH, the pH of a 1% aqueous solution is often used. The pH in a 1% (w/w) aqueous solution of the detergents contemplated in this invention ranges typically from pH 7 to 11, preferably from pH 7 to 10, even more preferably from pH 7 to about 9.6.

### EXAMPLES

### Example 1

### Stability of Savinase in a Typical American Liquid Detergent

A commercially available detergent from Unilever (Wisk) was heated to 85° C. for 5 minutes to inactivate any enzyme activity. After cooling 0.5% (w/w) Savinase 16 L™ (Novozymes A/S, Bagsvaerd, Denmark) was added to the detergent and samples were incubated at minus 18° C. or at 37° C. for 2 weeks in sealed vials. The residual activity is the activity of the sample stored at 37° C. relative to the activity of the parallel sample stored at −18° C.

After incubation the residual protease activities were determined by an assay based on the hydrolysis of N,N-dimethylcasein (DMC). Briefly, the protease activity is followed spectrophotometrically at 420 nm for 10 minutes after a pre-incubation period of 8 minutes. The assay is run at pH 8.3 and at 37° C. The following solutions are used for the assay: DMC-substrate: 0.4% N,N-dimethylcasein in 90 mM sodium tetraborate, 120 mM sodium phosphate, 0.2% Brij 35, adjusted to pH 8.0.

TNBS solution: 1.73 mM 2,4,6-trinitrobenzenesulfonic acid in water.

Dilution buffer: 0.15 M KCl, 0.05 M boric acid, 0.16 M sodium sulfite, 0.2% Brij 35 adjusted to pH 9.0.

For the assay, 80 μL TNBS solution is mixed with 45 μL sample or standard (diluted in dilution buffer) and the reaction is started by the addition of 160 μL DMC-substrate.

The results are presented in table 1.

The same procedure was performed with the detergent composition in which the added Savinase 16L additionally comprised 1% (w/w) Terminox Ultra 50L™ (Novozymes A/S, Bagsvaerd, Denmark), which is a catalase originating from Scytalidium thermophilum, resulting in a final concentration of catalase (Terminox Ultra 50L™) in the detergent of 0.005% (w/w).

TABLE 1
Savinase +/− Terminox Ultra 50 L

| | Residual protease activity (%) |
|---|---|
| | 2 weeks at 37° C. |
| 0.5% (w/w) Savinase 16 L ™ | 26 |
| Do + 0.005% (w/w) | 83 |
| Terminox Ultra 50 L ™ | |

The data in the Table 1 above clearly show that the addition of catalase present in Terminox Ultra 50 L results in stabilization of the protease during storage of the detergent composition.

### Example 2

### Stabilization of a Savinase Variant in Wisk From Unilever by Catalase

Another protease, a variant of Savinase disclosed in WO 89/06279 (subtilisin 309), having an insertion in position 99 (S99SE=*99aE), was used in an experiment for determining the stability of the detersive enzyme during storage in a detergent composition as previously described. The results are shown in table 2 below.

TABLE 2
Savinase variant +/− Terminox Ultra 50 L

| | Residual activity (%) | |
|---|---|---|
| | 2 weeks at 37° C. | 4 weeks at 37° C. |
| 0.5% (w/w) Savinase | 30 | 19 |
| variant | | |
| Do + 0.005% (w/w) | 85 | 80 |
| Terminox Ultra 50 L | | |

It is evident from the data, that also the Savinase variant was stabilized by the addition of catalase. The residual protease activity was determined as described earlier in Example 1.

### Example 3

A commercially available detergent from Unilever (Wisk) was heated to 85° C. for 5 minutes to inactivate any enzyme activity. After cooling the portion was split into two parts, A and B. Part A was added 0.5% (w/w) Savinase variant and part B was added 0.5% (w/w) Savinase variant plus 0.1% (w/w) methionine. The samples were incubated at −18° C. or 37° C. for 2 weeks in sealed vials after which the residual activity was determined. The results are shown in the table below.

TABLE 3

| | Methionine | | |
|---|---|---|---|
| Enzymes added to | added to | | Residual protease |
| detergent | detergent | Storage condition | activity (%) |
| Savinase variant | — | 2 weeks at −18° C. | 100 |
| Savinase variant | — | 2 weeks at 37° C. | 26 |
| Savinase variant | 0.1% | 2 weeks at −18° C. | 100 |
| Savinase variant | 0.1% | 2 weeks at 37° C. | 89 |

The stabilizing effect of methionine on the protease activity during storage is clearly demonstrated

### Example 4

A commercially available detergent from Unilever (Wisk) was heated to 85° C. for 5 minutes to inactivate any enzyme activity. After cooling the portion was split into two parts, A and B. Part A was added 0.5% (w/w) Savinase variant and part B was added 0.5% (w/w) Savinase variant plus 0.1% (w/w) ascorbate. The samples were incubated at −18° C. or 37° C. for 2 weeks in sealed vials after which the residual activity was determined. The results are shown in the table below.

TABLE 4

| | Ascorbate | | |
|---|---|---|---|
| Enzymes added to | added to | | Residual protease |
| detergent | detergent | Storage condition | activity (%) |
| Savinase variant | — | 2 weeks at −18° C. | 100 |
| Savinase variant | — | 2 weeks at 37° C. | 26 |
| Savinase variant | 0.1% | 2 weeks at −18° C. | 100 |
| Savinase variant | 0.1% | 2 weeks at 37° C. | 90 |

The stabilizing effect of ascorbate on the protease activity during storage is clearly demonstrated

1-18. (canceled)

19. A method of stabilizing a detersive enzyme in a liquid detergent composition comprising less than 90% of water, said method comprising adding an antioxidant to the liquid detergent, wherein said antioxidant is selected from the group consisting of catalase, methionine and ascorbate.

20. The method according to claim 19, wherein the detersive enzyme is selected from the group consisting of proteases, amylases, lipases, pectate lyases, carbohydrases and cellulases.

21. The method according to claim 19, wherein the liquid detergent comprises less than 85% of water by weight of the liquid detergent.

22. The method according to claim 19, wherein the liquid detergent comprises at least 1% water by weight of the liquid detergent.

23. The method according to claim 19, wherein the liquid detergent comprises between 30% to 70% water by weight of the liquid detergent.

24. The method according to claim 19, wherein the liquid detergent comprises less than 1% peroxygen species.

25. The method according to claim 19, wherein the catalase is from Aspergillus niger, Aspergillus oryzae, Scytalidium thermophilum, Micrococcus luteus, Streptomyces coelicolor, Thermomyces lanuginosus or Bacillus subtilis.

26. The method according to claim 19, wherein the antioxidant is present in the detergent before adding the enzyme.

27. The method according to claim 19, wherein the detersive enzyme is stabilized during storage.

28. The method according to claim 19, wherein the catalase is added in amount of less than 50 μg/g detergent.

29. The method according to claim 19, wherein the methionine or ascorbate is in an amount of more than 0.1 mg/g detergent.

30. The method of claim 19, wherein the antioxidant is catalase.

31. The method of claim 19, wherein the antioxidant is mehionine.

32. The method of claim 19, wherein the antioxidant is ascorbate.

33. A liquid detergent composition comprising a detersive enzyme, less than 90% of water (w/w) and an antioxidant selected from the group consisting of catalase, methionine and ascorbate.

34. The liquid detergent according to claim 33, wherein the catalase is in an amount of less than 50 μg/g detergent.

35. The liquid detergent according to claim 33, wherein the methionine or ascorbate is more than 0.1 mg/g detergent.

36. The liquid detergent according to claim 33, comprising less than 85% water by weight of the liquid detergent.

37. The liquid detergent according to claim 33, wherein the liquid detergent comprises at least 1% water by weight of the liquid detergent.

38. The liquid detergent according to claim 33, wherein the liquid detergent comprises between 30% and 70% of water by weight of the liquid detergent.
